(19) United States
(12) Patent Application Publication
(10) Pub. No.: US 2010/0280913 A1
(43) Pub. Date: Nov. 4, 2010

(54) GIFT CREDIT MATCHING ENGINE

(75) Inventors: Joseph O'SULLIVAN, Mountain View, CA (US); Marc E. Davis, San Francisco, CA (US); Christopher T. Paretti, San Francisco, CA (US); Christopher W. Higgins, Portland, OR (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/434,575

(22) Filed: May 1, 2009

(51) Int. Cl. G06Q 30/00

(52) U.S. Cl. 705/26

(57) ABSTRACT

A system and method to facilitate exchange of unwanted gifts is disclosed herein. A user may submit an unwanted gift in exchange for another gift item or a gift credit. Potential exchange gifts from among other unwanted gifts matching certain criteria are identified and presented to the user for selection. If the user does not find the potential exchange gifts to his liking, a gift credit having a value comparable to his/her submitted unwanted gift is issued to his account. As other users submit their unwanted gifts and/or as the value of the user's gift credit changes over time, the user may receive notification of new potential exchange gifts to choose from.

### CROSS-REFERENCE TO RELATED APPLICATIONS

The present application relates to U.S. patent application entitled “Gift Incentive Engine,” Attorney Docket No. 324212024600, filed on the same date herewith.

### BACKGROUND

The present invention relates to gift giving and exchanging. More particularly, the present invention relates to intelligent gift giving by taking into account the different needs of the involved parties at different points in the gift giving process as well as the preferences and needs of the gift recipient in selecting appropriate gifts and in handling unwanted gifts.

Gift selection and giving is a complex process. There are multiple parties involved at different points in the gift giving process—for example, there is at least a gift giver, gift recipient, gift vendor/merchant, and there may also be gift registers, party or event organizers or other related parties. Each of the parties has different motives, expectations, and information about the gift giving event and about each other. The gift giving process also has a multitude of stages, including gift event awareness and gift evaluation, selection, purchase, delivery, and consumption stages. To further complicate matters, there is also an overlay of societal expectations or norms implicit with giving and accepting gifts based on the social relatedness between the parties.

The gift giving process typically starts with a gift giver identifying a gift giving event (e.g., Christmas, birthday, anniversary, etc.) and figuring out what gift to give to the recipient. Once a gift has been selected, the gift giver determines which merchant to purchase the gift from. The selection of a particular merchant may depend on factors such as price, product availability, product quality, product features, delivery options, delivery reliability, merchant reputation, and/or return options. The gift giver may opt to have the merchant ship the purchased gift or may present the gift himself to the gift recipient. Upon receipt of the gift, the gift recipient may use (or not use) the gift as he sees fits.

Given such complexities, it is not uncommon for the gift giving experience to be less than satisfactory for the parties involved. The gift giver may not know if the selected gift is something that the gift recipient will like, but nevertheless feels that making a selection is necessary. The gift recipient may not like the received gift but may feel that he/she has to accept the gift. Given the stigma attached to gifting a received gift to another person, commonly referred to as re-gifting, the gift may not be used by anyone and the value of the gift is lost to society as a whole. Even potential gift vendors/merchants, who may be in a position to guide the gift giver in selecting a suitable gift, are not aware that a gift giver is searching for a gift and thus unable to better contribute to the gift giving process with information or incentives.

Attempts to make the gift giving process more transparent are less than successful. For example, having the gift recipient specify a gift to eliminate uncertainty in gift selection removes the element of surprise and may also obligate the gift giver to an uncomfortable price point or type of gift. Such explicitness can also devalue the gift and/or the entire gift giving process. Having an explicit gift registry also devalues the gift giving process, making gift giving more of a business transaction rather than a voluntary social interaction. Providing gift givers explicit insight to the ultimate disposition of a presented gift (e.g., gift recipient rejects the gift, gift recipient decides not to consume the gift, gift recipient sells or gives the gift to another person, etc.) similarly violates social norms and devalues the gift giving process. Since the gift giver typically seeks out a gift merchant after a gift selection has been made, gift merchants lack the opportunity to aid in gift selection and/or purchase. For example, gift merchants, advertisers, or sponsors are unable to differentiate or personalize targeting for specific gift occasions, gift recipients, or gift givers.

As such, a significant number of gifts go unwanted and unused—representing a great deal of inefficiency and waste of resources. Re-gifting or selling has a negative social connotation that discourages transparent secondary markets. A commercial-based exchange may involve tax liability. Even if a gift exchange or marketplace exists, accurate valuation of gifts is difficult, especially relative to the gift recipient and/or downstream consumers, and the relative relatedness of the users in the exchange is not taken into account.

Thus, it would be beneficial to receive unobtrusive input from the gift giver, gift recipient, and gift merchants/sponsors at different points in the gift giving process as well as having a non-monetary exchange engine and valuation models for personalized gift exchange matching in cases of unwanted gifts. It would be beneficial to factor in the received input from various interested parties during the gift giving process in order to iteratively refine and identify suitable gifts, or to facilitate the efficient exchange of any unwanted gifts through a secondary barter market. It would be beneficial to enable personalized valuation of potential gifts for each gift-giving event for a particular gift giver-recipient pair or particular gift exchange pair. It would be beneficial to take advantage of historical gift transaction data, social network data, and advertiser, merchant, or sponsor data to streamline the gift selection and purchasing process as well as providing new opportunities for targeted advertising or incentives for specific gifts. It would be beneficial to improve enjoyment of the gift giving process for all interested parties. It would be beneficial to dynamically value unwanted gifts for downstream consumption. It would be beneficial to create a comprehensive exchange to efficiently redistribute unwanted gifts while reducing negative social connotations associated with re-gifting or selling unwanted gifts and without creating taxable events.

### BRIEF SUMMARY

A gift exchange engine provides a distributed web application for managing posting, valuation, matching, re-distribution/exchange, and redemption of unwanted new or used gifts. A barter exchange marketplace is provided that does not evoke tax incurring economic activity. Real-time matching of available gifts to new gift recipients occurs using user profiling, gift characteristics, user requests, and interest-based marketing, facilitating better social utilization of gifts without the negative connotations associated with re-gifting. Unwanted gifts may be dynamically valued relative to each other, current market conditions, and/or relative to relevant users, all of which facilitates successful downstream consumption of unwanted gifts. Gift recipient offering his/her unwanted gift to the system may receive a gift credit (possibly for later redemption) and/or may select an exchange gift item from among the selections proposed by the system. Leveraging the wealth of information known abut the gift recipient, unwanted gift, potential exchange gifts, and/or other factors relating to the particular gift exchange, the system may also determine a matching advertisement or incentive to present to the gift recipient along with the potential exchange gift selections. Such advertisement or incentive is likely to be highly relevant, and accordingly the sponsor of the advertisement or incentive is more likely to pay a placement premium.

In one embodiment of the invention, a method is performed using a processor for exchanging unwanted gifts. The method includes creating a gift credit in response to submission of an unwanted gift, wherein the unwanted gift is submitted by a gift recipient. The method further includes identifying at least one exchange gift for the gift credit, and, requesting from the gift recipient, exchange of the gift credit for the exchange gift. The further includes initiating distribution of the exchange gift to the gift recipient if the exchange request is accepted or otherwise providing the gift credit to the gift recipient's account.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined by the claims attached hereto.

### BRIEF DESCRIPTION OF THE DRAWINGS

The exemplary embodiments will become more fully understood from the following detailed description, taken in conjunction with the accompanying drawings, wherein the reference numeral denote similar elements, in which:

FIG. 1A illustrates a block diagram of a gift exchange system in accordance with embodiments of the invention.

FIG. 1B illustrates a block diagram of an alternative embodiment of the gift exchange system.

FIG. 2 illustrates a block diagram of gift exchange modules included in the system of FIG. 1 in accordance with embodiments of the invention.

FIGS. 3A-3C illustrate flow diagrams associated with a gift incentive engine in accordance with embodiments of the invention.

FIG. 4 illustrates a flow diagram associated with a gift credit matching engine in accordance with embodiments of the invention.

The headings provided herein are for convenience only and do not necessarily affect the scope or meaning of the claimed invention.

### DETAILED DESCRIPTION

Described in detail below is an apparatus and method for facilitating gift giving through all stages of a gift cycle. Input from a gift giver, gift recipient, merchants, and potential downstream gift recipient(s) are requested at various points in the gift cycle to improve gift selection, evaluation, purchase, delivery, consumption, and exchange over time.

The following description provides specific details for a thorough understanding of, and enabling description for, embodiments of the invention. However, one skilled in the art will understand that the invention may be practiced without these details. In other instances, well-known structures and functions have not been shown or described in detail to avoid unnecessarily obscuring the description of the embodiments of the invention.

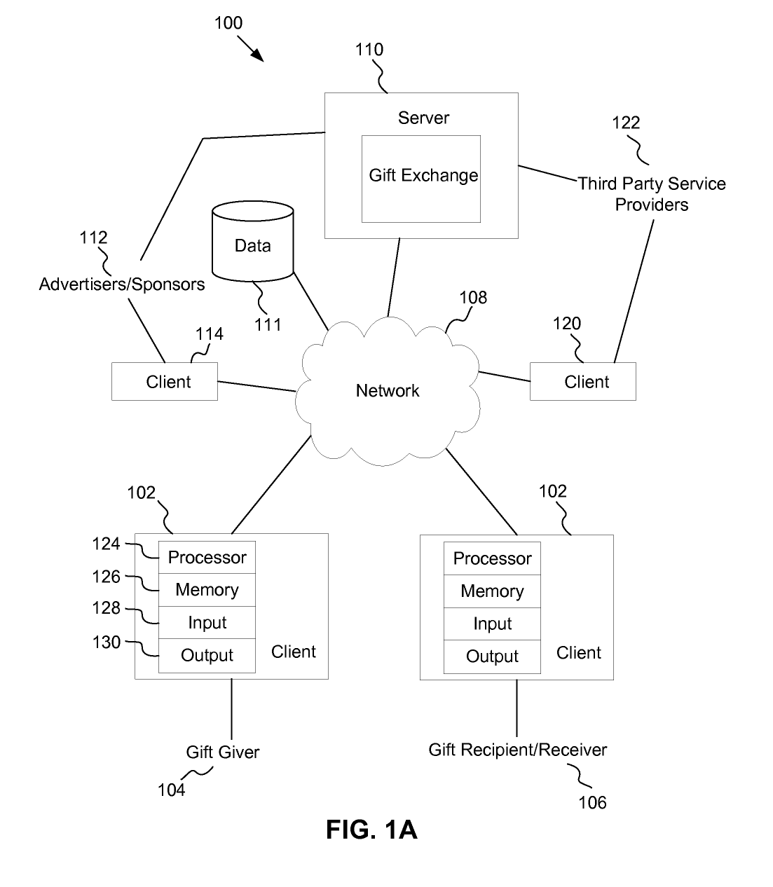

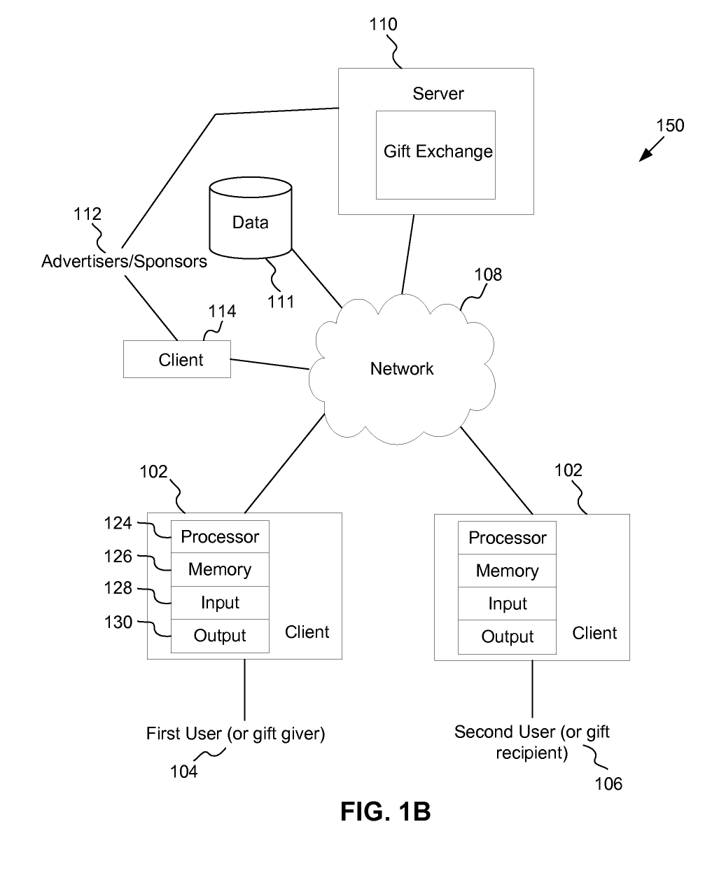

FIG. 1A illustrates a block diagram of a gift exchange system 100 in accordance with embodiments of the invention. The system 100 includes a plurality of clients 102, a network 108, a server 110, a database 111, and clients 114 and 120. Each of the clients 102, server 110, database 111, and clients 114, 120 is in communication with the network 108.

Each of the clients 102, 114, and 120 includes at least a processor 124, a memory 126, an input device 128 (e.g., keyboard or mouse), and an output device 130 (e.g., display). Each of the clients 102, 114, and 120 (also referred to as client devices or units) may be a general purpose computer (e.g., personal computer), specialized work station, or other computer system configurations, including Internet appliances, hand-held devices, wireless devices, portable devices, wearable computers, cellular or mobile phones, portable digital assistants (PDAs), multi-processor systems, microprocessor-based or programmable consumer electronics, game consoles, set-top boxes, network PCs, mini-computers, and the like. Each of the clients 102, 114, and 120 includes one or more applications, program modules, plug-ins, and/or sub-routines. As an example, the clients 102, 114, 120 can include a web browser application (e.g., Internet Explorer, Firefox, etc.) to access web sites, web pages, or web-based applications provided by the server 110 and data stored in the database 111. The clients 102, 114, 120 may be located geographically dispersed from each other, the server 110, and/or the database 111. Although one of the clients 102 is shown accessed by a gift giver 104 (also referred to a gift buyer or purchaser), another of the clients 102 is shown accessed by a gift recipient or receiver 106, the client 114 is shown accessed by advertisers/sponsors 112, and the client 120 is shown accessed by third party service providers 122, more than one client device may be included in the system 100 for each of the gift givers 104, gift recipient 106, advertisers/sponsors 112, and/or third party service providers 122.

The network 108 comprises a communications network, such as a local area network (LAN), a wide area network (WAN), or the Internet. When the network 108 comprises a public network, security features (e.g., VPN/SSL secure transport) may be included to ensure only authorized access within the system 100. Different access rights or security requirements may apply to different parties using the system 100. For example, advertisers/sponsors 112 or third party service providers 122 may require access to different features of the system 100 than gift givers 104 or gift recipients 106.

The database 111 is operable to store data provided by and/or used by the server 110, clients 102, client 114, client 120, advertisers/sponsors 112, and/or third party service providers 122. The database 111 may additionally store data associated with social networks, past gift transactions, product reviews by the general public, or other information beneficial for gift selection, purchase, valuation, and/or redistribution but which is not necessarily from the gift givers 104, gift recipients 106, advertisers/sponsors 112, and/or third party service providers 122.

The server 110 is operable to provide content, web-based applications, user interfaces, web pages, process data, and/or facilitate gift exchange to the gift givers 104, gift recipients 106, advertisers/sponsors 112, and third party service providers 122. The server 110 includes a gift exchange module or engine, to be discussed in detail below. The gift givers 104 and gift recipients 106 communicate with the server 110 via the clients 102 and network 108. The advertisers/sponsors 112 and third party service providers 122 communicate directly with the server 110 and/or indirectly via the network 108. One or both communication pathways may be utilized depending on security concerns, amount of data transfer, need for additional configuration to provide component compatibility, availability of dedicated direct interfaces to the server 110, and other system requirements.

The server 110 may comprise one or more servers, depending on computational and/or distributed computing environments. The database 111 may also comprise one or more databases, depending on computational, storage, and/or distributed computing environments. The server 110 and database 111 may be located at different geographic locations relative to each other. In certain embodiments, the server 110 may include the database 111, processors, switches, routers, interfaces, and/or other components and modules. The database 111 may be directly coupled to the server 110 rather than being accessed via the network 108. The system 100 may be comprised of multiple (interconnected) networks such as local area networks or wide area networks.

The advertisers/sponsors 112 and third party service providers 122 comprise, but are not limited to, merchants, vendors, manufacturers, advertisers, service providers, experts, specialists, or others who may benefit from the gift selection, purchase, delivery, and/or consumption process or stages. For example, the advertisers/sponsors 112 may comprise online or retail business advertisers, and third party service providers 122 may comprise all other interested parties (other than the gift giver and recipient) who have input into the gift giving process or responsibilities associated with the gift event including personal gift assistance professionals. The advertisers/sponsors 112 and third party service providers 122 may provide initial and iteratively refined gift suggestions and incentives, facilitate purchase or delivery of a selected gift, facilitate consumption of the provided gift, or aid in valuation of unwanted gifts either directly or through additional third party aggregator services. Each of such providers and/or services may or may not be combined with each other. For example, the advertisers/sponsors 112 may directly manage their own account on the gift exchange or may hire a specialized marketing professional to act on their behalf. Similarly, the third party service providers 122 may act independently or on behalf of one or more of the gift givers 104.

Although not shown, the server 110 may include one or more application programming interfaces (APIs) to facilitate interfacing with the gift exchange. The APIs serve as programmatic interfaces if, for example, the advertisers/sponsors 112 or third party service providers 122 cannot or do not have a web application for account or information management. Such may be the case if the clients 114 or 120 are not available. The APIs comprise a set of function calls to the server 110 hosting the gift exchange to allow backend access to gift exchange functions.

FIG. 1B illustrates a block diagram of a gift exchange system 150 in accordance with other embodiments of the invention. It is contemplated that FIG. 1A relates to a gift incentive engine and FIG. 1B relates to a gift credit matching engine. The system 150 is similar to the system 100 except the third party service providers 122 and client 120 are optional. Additionally, the gift giver 104 may be referred to as a first user 104 and the gift recipient 106 may be referred to as a second user 106, since the parties involved need not necessarily be a gift giver-recipient pairing downstream of the original gift giver and recipient for a given gift.

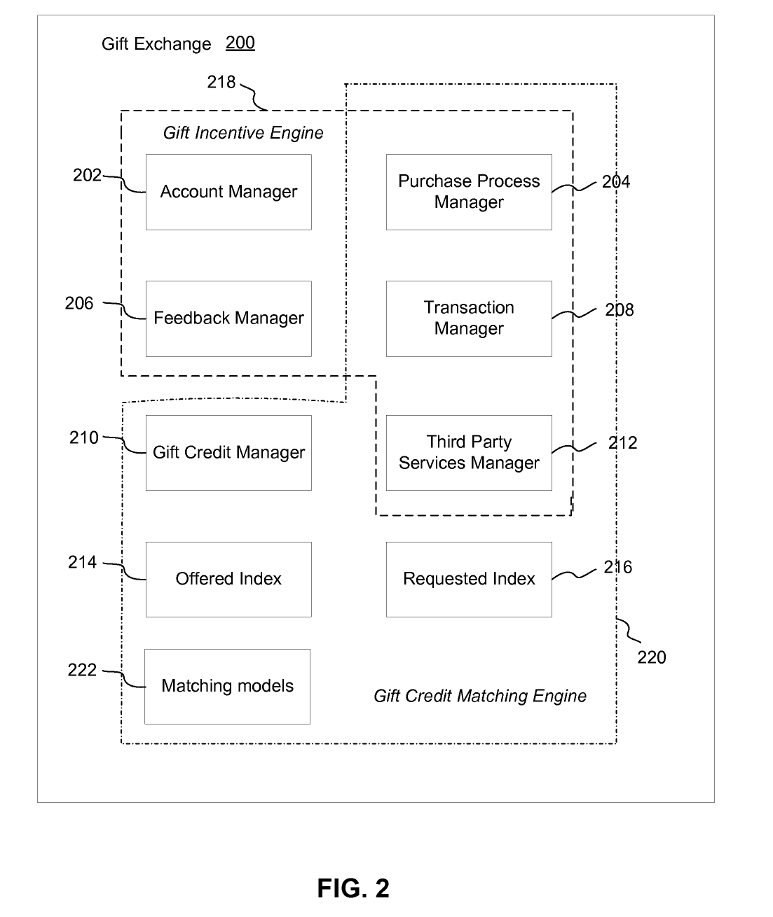

FIG. 2 illustrates a block diagram of gift exchange modules included in the server 110 in accordance with embodiments of the invention. Gift exchange module or engine 200 comprises a plurality of modules or sub-modules which comprise, but are not limited to, an account manager module 202, a purchase process manager module 204, a feedback manager module 206, a transaction manager module 208, a gift credit manager module 210, a third party services manager module 212, an offered index module 214, a requested index module 216, and a matching models module 222.

These modules interact with each other and can be dynamically accessed to facilitate gift exchange. A gift incentive engine 218 is operable to facilitate gift selection, evaluation, purchase, and delivery. The gift incentive engine 218 comprises the account manager module 202, purchase process manager module 204, feedback manager module 206, transaction manager module 208, and third party services manager module 212. A gift credit matching engine 220 is operable to facilitate handling, valuation, and consumption of unwanted gifts. The gift credit matching engine 220 comprises a purchase process manager module 204, transaction manager module 208, gift credit manager module 210, third party services manager 212, offered index module 214, requested index module 216, and a matching models module 222. The gift credit matching engine 220 (also referred as a gift exchange engine) may be a stand alone application, interoperate with the gift incentive engine 218, or interoperate with other gift process facilitation software or system (e.g., as a plug-in).

The modules or engines discussed herein may be modules, portions of modules, scripts, batch, executable files, routines, subroutines, computer programs, or combinations and/or portions of such files. They may be implemented in software encoded on computer-readable media, firmware, and/or hardware. Additionally, the boundaries between modules are merely illustrative and alternative embodiments may merge, combine, or alternatively group the functionality of modules. For example, modules discussed herein may be decomposed into submodules to be executed as multiple computer processes or by multiple processors. It is also contemplated that functionalities may be combined or distributed as needed to meet various requirements such as response time, load balancing, cost constraints, user demands, etc.

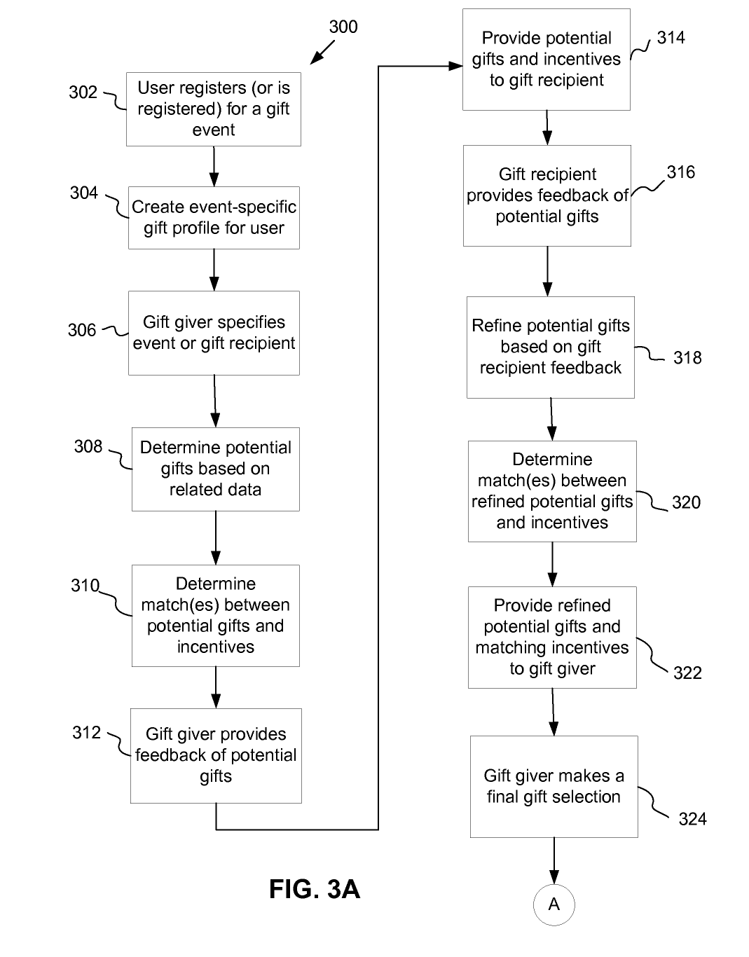

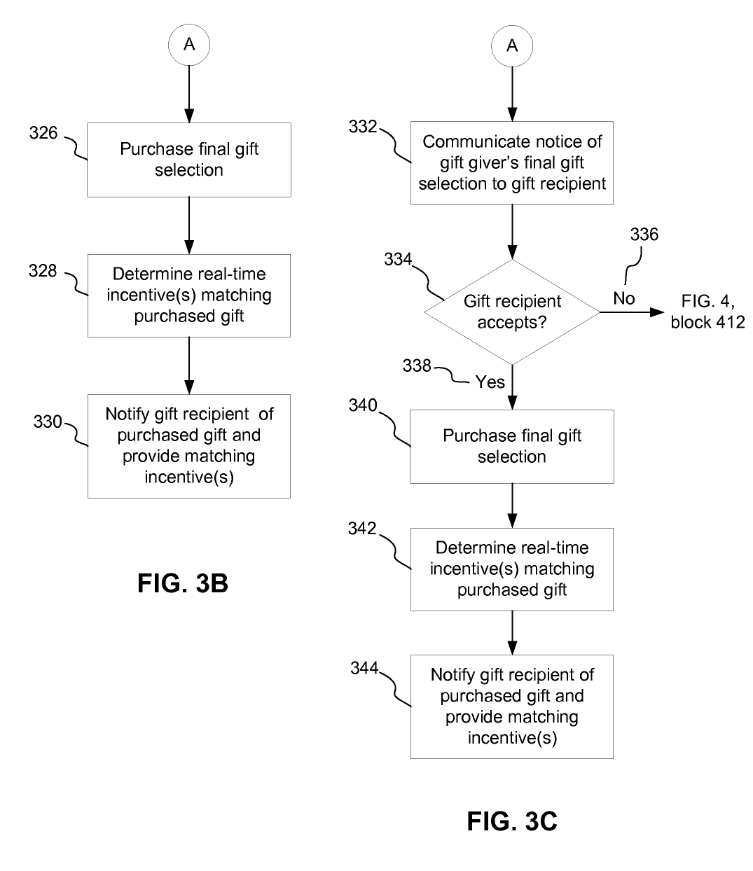

FIG. 3A illustrates a flow diagram 300 in connection with the gift incentive engine 218 in accordance with embodiments of the invention. The flow diagram 300 includes registering for a gift event block 302, a create event-specific gift profile block 304, a gift giver specifies event or gift recipient block 306, a determine potential gifts based on related data block 308, a determine match(es) between potential gifts and incentives block 310, a gift giver selects potential gifts block 312, a provide potential gifts and incentives to gift recipient block 314, a gift recipient feedback block 316, a refine potential gifts based on gift recipient feedback block 318, a determine match between potential gifts and incentives block 320, a provide refined potential gifts and incentives to gift giver block 322, and a gift selection block 324.

The server 110 provides an interactive web-based application enabling the gift incentive engine 218. At the block 302, a registration feature is made available to users or others to register for gift events. Users may be gift recipients who self-register or others may register for the gift recipients such as the gift giver, a third party, or via an automated mechanism or system. A gift event can be any occasion that is recognized as a gift giving occasion between two parties. Examples of gift events include, but are not limited to, birthdays, anniversaries, Christmas, Hanukkah, graduations, weddings, baby showers, Mother's day, Father's day, job promotions, etc. Any number of user interfaces may be provided by the gift incentive engine 218 to facilitate gift event registration. For example, users may use the clients 102 to access the web-based application, and the web-based application can provide a number of registration fields to be filled-in to register for a gift event such as, but not necessarily limited to, a login/password identifier, intended gift recipient, gift event, date of gift event, additional particulars regarding the gift event, preferences of the gift recipient (either generally or as it relates to the gift event), and/or other information pertinent to registering the gift event for the particular gift recipient. In other embodiments, the registration process may be interactive to help refine gift potentials at the time of the registration. The registering user or intended gift recipient may be provided a series of questions, ratings, and/or selections to initialize gift categories, vendors, or specific items likely to rate high as appropriate gifts for the event. Obtaining as much information as possible at the onset increases the probability of better matched gifts as the gift giving process continues.

The account manager module 202 creates an interest-based, event-specific gift profile for the gift recipient at the block 304. The profile can be based on a variety of information, including but not limited to, registration data, existing user profile, user transaction history, previous gift exchange transactions, profiles of other users, transaction history of other users, previous gift exchange transactions by other users, and/or other known spatial, temporal, social or topical data associated with the user, event or related gifts or potential gifts. Such gift profiles may be stored in the database 111. Over time, the gift exchange 200 provides better recommendations of gifts as the amount of actual feedback of gift suggestions and incentives increase over time.

Once a gift event has been registered with the gift exchange 200, a person (e.g., the gift giver, the gift recipient, a third party, or an automated mechanism or system) wishing to purchase a gift expresses interest in a particular gift event and/or gift recipient (block 306). Interest in the particular gift event and/or gift recipient can be expressed in a variety of ways, such as by interacting with the purchase process manager module 204 via a web-based application, electronic mail (email), or other forms of communication that are compatible with the gift exchange 200.

Next, at the blocks 308-310, at least some of the data included in the profile is used to determine initial gift suggestions and incentives appropriate for the gift event and gift recipient. In one embodiment, the profile data is shared with advertisers/sponsors 112 and/or third party providers 122 in order to receive their input for initial gift suggestions and incentives. In some instances, the determination of initial gift suggestions and incentives may be provided by the advertisers/sponsors 112 and/or third party providers 122. Incentives may include monetary and non-monetary forms, but are not limited to, discounts, special deals, trusted vendors, advertisement for separate product purchase opportunities, advertisement pertaining to potential gifts, sponsor matches to gift suggestions, or purchasing incentives that may be mutually beneficial to the gift buyer and recipient. The third party services manager 212 facilitates the information exchange with the advertisers/sponsors 112 and/or third party providers 122.

The potential gifts (or gift suggestions) may be determined using related data at the block 308. Related data includes data from all known sources and networks including, but not limited to, user profiles, user accounts, user authored web pages, social networks, professional associations, telecommunication providers, Internet service providers, wireless carriers, credit card transactions, communications metadata, content of user communications, user location and/or path data, and/or intersections and associations pertaining to the potential gifts, gift giver, gift recipient, related persons, gift event, and/or other related factors. Related data may also include advertiser or incentive targeting models or profile data based on real-time advertisement copy or incentive inventory within the system or related source of advertisements or incentives. For example, if a gift recipient's friend's wife already has one of the potential gifts and wrote positive reviews about the item on her blog, such social relations can be used as the starting point for gathering related data. The impression of a potential gift from a person within the gift recipient's sphere of influence would also be relevant in whether the potential gift remains as a potential gift. The feedback manager module 206 is involved in gathering social network data and processing such data to identify and leverage intersections and associations relevant to refining the current potential gifts. Likewise credit card transaction data may indicate known inventory of a target user and may help in removing any items already purchased by the user or by another gift giver associated with the specific gift event. Refinement can include calculating a priority or weight value for each potential gift as well as eliminating or replacing one or more of the potential gifts with other potential gifts. The number of potential gifts resulting from refinement may vary as appropriate for the gift event, based on a preset minimal weight value, based on initial number of gift suggestions and incentives, or as constrained by computational requirements or available data.

The identified potential gifts are then matched to incentives, such as coupons, discount offers, offers on accessories to the potential gift, sponsored content, and third party service offers, at the block 310 by the third party services manager module 212.

Next, the person wishing to purchase a gift or a portion of the gift (such as the gift giver 104 or a gift giver proxy) may be presented gift suggestions and incentives determined at the blocks 308-310. At the block 312, the feedback manager module 206 is operable to permit the gift giver to select, delete, rank, group, approve with conditions, rate, or otherwise give feedback of the gift suggestions (and incentives) determined at the blocks 308-310. In alternative embodiments, the gift giver selects potential gifts block 312 may be omitted. Instead, either the gift giver may propose a personalized list of potential gifts, or the gift giver does not have input at this stage as to the potential gifts.

The initial list of potential gifts and also possibly the incentives may be refined based on the gift giver feedback by the feedback manager module 206. Refinement can include calculating a priority or weight value for each potential gift as well as eliminating or replacing one or more of the potential gifts with other potential gifts. The number of potential gifts resulting from refinement may vary as appropriate for the gift event, based on a preset minimal weight value, based on initial number of gift suggestions and incentives, or as constrained by computational requirements or available data. Incentives may similarly be refined. In alternative embodiments, refinement based on gift giver feedback may be deferred until after the gift recipient has also provided feedback. In such case, refinement based on the gift giver feedback may occur at the block 318.

The list of (refined) potential gifts and also possibly the matching incentives are provided to the gift recipient at the block 314 via email, instant messaging (IM), short message service (SMS), or a variety of other communication mechanisms. Even if the actual list of refined potential gifts is not presented to the gift recipient, a notification to login to the web-based application to provide feedback is sufficient. The notification could include a hyperlink to the web-based application or a particular webpage displaying the potential gifts and providing an interactive means to select, deselect, rank, order, group, or otherwise provide feedback as to the user's desire to receive a particular item as a gift.

In response, at the block 316, the gift recipient interacts with the received communication or the gift exchange web-based application to rank, rate, eliminate, select, modify, interact with, or otherwise indicate reactions and preferences to the refined potential gifts. The gift recipient may also be able to obtain information about each refined potential gift such as available colors, sizes, configuration options, material options, product features, accessories, specifications, etc. to further aid in obtaining feedback. Feedback from the gift recipient may include information to add new potential gifts to the set of refined potential gifts. The feedback is captured by the feedback manager module 206.

The feedback manager module 206 is operable to use the gift recipient's feedback to further refine or filter the refined potential gifts (block 318). This second level of refinement (the first level of refinement occurring at the block 312) may include re-prioritizing the refined potential gifts relative to each other, adding specified product options (if applicable) to certain refined potential gifts (e.g., including the gift recipient's preference for the color red from among the color options for a particular potential gift), replacing a refined potential gift with another potential gift that better fits the gift recipient's feedback, eliminating refined potential gifts that the gift recipient indicated as not liking, or other filtering actions to improve the list of potential gifts.

Once the gift recipient's feedback has been incorporated into the latest list of refined potential gifts, the third party services manager module 212 determines match(es) between the latest list of refined potential gifts and incentives (block 320). The third party services manager module 212 at the block 320 (and at other blocks) interacts with advertisers/sponsors 112, third party service providers 122, sponsor provided content repositories, advertisement networks, third party services networks, and/or other sources of incentive information to identify a set of incentives tailored to the list of potential gifts. Suitable incentives are those that provide the most meaningful options for the gift giver as he gets ready to make a final gift selection, such as purchasing options, price options, merchants with available stock, and/or other inducements for the gift giver to make a purchase.

The gift giver is presented with a final set of potential gifts and matching incentives at the block 322. The purchase process manager module 204 receives a final gift selection from the gift giver at the block 324. The gift giver has the freedom to make the final gift selection using one of the presented incentives or by independently seeking out a (physical or online) merchant. If the gift giver decides to use one of the presented incentives, the gift incentive engine 218 is operable to (automatically) direct the gift giver to the website/web page associated with that advertiser or third party service provider in order to complete the transaction.

FIG. 3B illustrates a flow diagram for completing the transaction in accordance with an embodiment of the invention. After the gift selection block 324, a purchase final gift selection block 326 is implemented using the purchase process manager module 208 and/or transaction manager module 208. The purchased gift is used to determine matching real-time incentive(s) via the third party services manager module 212 (block 328). Next at a block 330, the intended gift recipient is automatically notified of the purchased gift and the matching incentive(s) by, for example, the transaction manager module 208. Similar to the communications discussed with respect to block 314, the gift purchase notification may also be carried out in any of a variety of communication schemes.

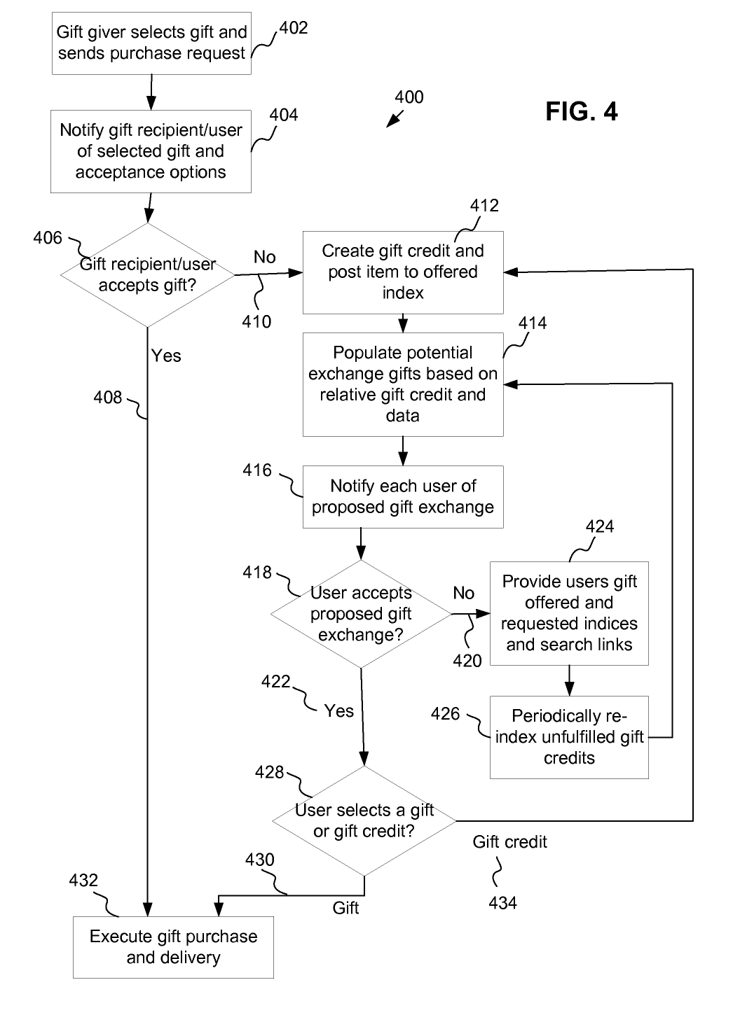

FIG. 3C illustrates a flow diagram for completing the transaction in accordance with an alternative embodiment of the invention. After the gift selection block 324, the transaction manager module 208 or purchase process manager module 204 may notify the gift recipient of the gift giver's final gift selection prior to actual purchase of the gift by the gift giver (block 332). This allows the gift recipient to accept (branch 338) or reject (branch 336) the gift giver's final gift selection at a block 334. Even after the multiple layers of gift refinement, it may be possible that the gift recipient would not like the final gift selection. Such notification prior to purchase decreases purchases of unwanted gifts. Rejection of the final gift selection will be discussed in detail with respect to FIG. 4.

If the gift recipient accepts the final gift selection (branch 338), then the final gift selection may be purchased with the aid of the purchase process manager module 204 and/or transaction manager module 208 at a block 340. Latest or real-time incentive(s) matching the purchased gift are determine at a block 342, and then the gift recipient is notified of the purchased gift and matching incentive(s) at a block 344. Blocks 340, 342, 344 are similar to blocks 326, 328, 330, respectively.

Although not shown in FIGS. 3A-3C, after notification of the purchased gift to the gift recipient, the purchased gift may then be delivered to (or picked up by) the gift recipient, the gift giver may be notified of the delivery, and the gift recipient may be offered thank-you services, satisfaction survey requests, follow-up targeted advertisement, and the like.

In general, gift suggestions and incentives posed to various parties at different points in the gift giving process may be generated based at least in part on input from the gift giver, the gift recipient, any interested third party, a social contact of the gift giver (e.g., a relative, personal assistant, friend, co-worker, etc.), an advertiser, a sponsor, a market researcher, a buying specialist, and/or market research professionals. Gift feedback from various parties may comprise selection from among a set of potential gifts, ranking of suggested gifts, rating of suggested gifts, or specification of new potential gifts.

It is contemplated that although a certain sequential order is illustrated in FIGS. 3A-3C, certain blocks may be performed in a different sequence, simultaneously, and/or omitted. For example, block 306 may be implemented after blocks 308 and/or 310. As another example, blocks 304 and 308 may be carried out at the same time. As still another example, block 312 may be omitted. It is also contemplated that the gift giver may be more than one person/entity for a particular gift event and gift recipient. In this case, feedback from the gift givers are collated into a composite feedback. It is also contemplated that the gift giver discussed above may be a different person/entity from the gift buyer or the one making the final gift selection. The selected and/or purchased gift need not be a product or service. Instead, the gift may be a gift credit that is redeemable for a product or service within the gift exchange environment.

Accordingly, the gift incentive engine 218 combines an interactive distributed environment for gathering anonymous (and opaque) gift selection advice from relevant parties in conjunction with a customized, commercial/monetized content providing environment at every stage of the gift evaluation, selection, purchase, delivery, and consumption stages. The gift incentive engine 218 expects greater participation from gift buyers/givers, gift recipients, and advertisers/third party product and service providers, thereby increasing the efficiency of buying a gift and increasing the likelihood that the gift receiver will be satisfied with the gift. However, the gift giver and gift recipient do not have direct information about each other's selections/rejections, which helps to preserve their relationship, even though each is aware that both are providing input to narrow down the gift selection. The gift incentive engine 219 better matches sponsors and sponsor content at each stage by using personalized data for the particular gift transaction, which provides an efficient use of the sponsor's limited resources rather than sending incentives to the population-at-large or persons who are not in the gift cycle.

The gift exchange 200 is further configured to be an intermediary for the gift cycle and facilitate redistribution of unwanted gifts until a party actually accepts a potential gift or exchanges a gift previously accepted but now unwanted.

FIG. 4 illustrates a flow diagram 400 in connection with the gift credit matching engine 220 in accordance with embodiments of the invention. The flow diagram 400 includes a select gift and send purchase request block 402, a notify gift giver of selected gift block 404, a gift acceptance decision block 406, a credit gift credit and post to offered index block 412, a populate potential exchange gifts block 414, a notify each user of proposed gift exchange block 416, a acceptance of proposed gift exchange decision block 418, a provide users gift offered information block 424, periodically re-index block 426, a user selection decision block 428, and an execute gift purchase and delivery block 432.

At the block 402, a gift giver selects a gift and initiates a request to purchase the selected gift via the purchase process manager module 204. The gift selection may occur using the gift incentive engine 200 (e.g., as discussed in FIG. 3A) or other gift purchase facilitation applications. However, prior to actual purchase and delivery of the selected gift to the gift recipient, the transaction manager module 208 provides a notice of the selected gift to the intended gift recipient (block 404). The notification may also include options and/or instructions for accepting or rejecting the selected gift. The notification may be via email, IM, SMS, or other forms of communication. In certain embodiments, the block 404 may be similar to block 332 in FIG. 3C.

At the block 406, the intended gift recipient is given the option to accept or reject the gift. If the gift is accepted (branch 408), then gift purchase and delivery can take place (block 432). Otherwise, if the gift is not wanted by the gift recipient (branch 410), then the purchase of the gift does not occur. Instead the gift credit matching engine 220 is operable to initiate a gift credit scheme to handle the unwanted gift and to provide the gift recipient with a different gift of his choosing (the different gift may not be immediately available for the gift recipient). In some embodiments where a gift is given by the gift giver but never purchased or delivered to the gift recipient, some or the entire purchase price of the selected gift may be available to the gift recipient in the form of a gift credit or cash equivalent.

When the gift recipient rejects the gift selected by the gift giver, the transaction manager module 208 creates a gift credit for the unwanted gift, applies the gift credit to an account associated with the gift recipient, and posts the gift credit to an offered index module 214 (block 412). Rather than the gift recipient taking possession of a unwanted gift, and then having to return or exchange it for something else, the gift credit matching engine 220 permits the gift recipient to keep the rights to a gift, of comparable value to the gift being surrendered, for as long as necessary to be matched to a gift more to his liking. The offered index module 214, also referred to as an unwanted gift registry, contains an entry and information about every unwanted gift for which a gift credit has been created.

The gift credit may include a value of the surrendered gift. The gift credit may include other information about the gift, such as the date of the gift surrender, details about the gift (e.g., color, model number, configuration, etc.), the gift giver, history of gift valuation (s), or the like to aid in present or future valuation and/or matching operations. Gift credits may thus be associated with a specific unwanted gift (and its current estimated value) that is registered and offered for exchange, or gift credits may have a cash value. In one embodiment, the gift value may be determined at (or soon after) the gift is rejected by the gift recipient. The gift exchange 200 takes over rights to the gift upon creation of the gift credit, and can then use the gift for actual redemption by another person or to return to the merchant or gift giver. The gift valuation is usually done once in connection with the creation of a gift credit.

In alternative embodiments, the gift value may be determined at (or soon after) the gift is rejected by the gift recipient and at one or more later points in time based upon the then current gift exchange data (including, for example, after the gift recipient has taken possession and used the gift for a period of time). The rights to the gift remains with the gift recipient (in the gift recipient's account) until the gift recipient transfers the rights to the gift to the gift exchange 200. Such transference may comprise acceptance of the gift credit by the gift recipient at a gift value determined by the gift exchange 200. At any point in time prior to transfer of the rights to the gift to the gift exchange 200, the gift recipient may request the gift exchange 200 to update the gift value so that he can determine whether to accept the gift credit. The gift value may fluctuate over time depending on factors such as the availability of gifts, gift credits, and/or gift requests within the gift exchange 200, availability of gifts in the general marketplace, purchase price, etc. In other alternative embodiments, the gift credit matching engine 220 may issue gift credits for rejected gifts and take over rights to the rejected gifts, but the value of rejected gifts are not made known to the users (e.g., gift recipients) except in the relative sense as matching gifts for redemption of gift credits occur. The gift credit matching engine 220 may value all gifts currently available in the gift exchange 200 relative to each other for purposes of proposing potential gift exchanges.

Next at the block 414, the gift credit manager module 210 determines potential gifts for the gift recipient to redeem or exchange for the created gift credit. The potential gifts, also referred to as potential gift exchanges, are determined based at least in part based on the gift value associated with the gift credit and other data. Gifts suitable for exchange are selected from those currently posted in the offered index 214 and/or requested index 216. The requested index 216 comprises information about the requested or desired gifts that a gift recipient may be willing to exchange for the registered gift or gift credit. The matching models module 222 (also referred to as dynamic matching models) is operable to dynamically determine potentially suitable gift exchanges using, but not limited to, specific user-designated valuation, specific user-designated gift or item (user requested exchange item), relative current resale value of gifts, relative value of gifts, relative relatedness between the gift recipient and another user associated with another gift, or relative relatedness of gifts (e.g., manufacturer, brand, category, use or purpose, etc.). The offered index 214 and requested index 216 are matched in various ways depending on the actual matching model used including, but not limited to, exact matches, categorical matches, match by manufacturer or brand, match by use or purpose, match by resale values, match by personal valuations, matches based on a preset degree of similarity, or a variety of other matching models. Gifts suitable for exchange are dynamic and may change over time as offered gifts, requested gifts, or gift values change. In general, gifts suitable of exchange comprise gifts with relative similar value as the gift recipient's gift credit value. Additionally, user data may be used to determine which of the relative similarly valued gifts are suitable for the gift recipient, such as personalized value estimates. For example, user data may comprise data about the gift recipient (e.g., the gift recipient's profile, purchase history, history within the gift exchange 200, website navigation and activity history, preferences (explicitly or implicitly collected), and/or other information), data from social networks, intersections or associations extracted from social networks, data from sponsors, marketers, and merchants, and/or the like. User data may comprise known information about the gift event. User data may comprise available requested gifts. Since a new gift has been added for gift exchange, the gift credit manager module 210 may determine potential exchange gifts for one, more than one, or all of the users with outstanding gift credits. Data used to find matching exchange gifts may include spatial, temporal, social, or topical data related to the gift recipient, the gift giver, a gift event, or a requested exchange gift from the gift recipient.

Part of the matching process may include identifying at least one advertisement and/or incentive that matches the respective potential exchange gift. Examples of advertisements and/or incentives include products or services related to the potential exchange gifts. The third party services manager module 212 may be evoked to obtain the necessary advertisement and incentive data.

In alternative embodiments there may be a block provided before block 414 in order for the gift recipient to specify or request a particular exchange gift as a condition submitting or surrendering his/her unwanted gift. In such a case, at least one of the potential exchange gifts proposed to the gift recipient should at least partially match his/her requested particular exchange gift. For example, the match may be a match to the requested particular exchange gift, a manufacturer of the particular exchange gift, a use or purpose of the particular exchange gift, or a relative resale value of the particular exchange gift. The requested particular exchange gift need not be included in the requested index 216.

Once potential exchange gifts have been determined, the transaction manager 208 at the block 416 notifies or communicates the proposed exchange gifts (and matching advertisements and/or incentives) to relevant users. Depending on whether the rights to gifts have been surrendered by the original gift recipients, whether potential exchange gifts are determined for more than one user, and/or the extent of the potential exchange gifts found, the number of relevant users can vary. For example, if only a gift exchange for the gift recipient who just rejected a gift is being addressed in the block 414, the system identified five potential exchange gifts for the rejected gift, and each of the five potential exchange gifts is still “owned” by five different users, then a total of six notifications would be required, one notification for the gift recipient and the remaining five notifications for the five different users who are “owners” of the potential exchange gifts. As another example, if only a gift exchange for the gift recipient who just rejected a gift is being addressed in the block 414, the system identified five potential exchange gifts for the rejected gift, but the system was set up such that rights to rejected gifts have already been transferred to the gift exchange 200, then merely the gift recipient needs receive a notification of the five potential exchange gifts. As still another example, if the system calculates potential exchange gifts for all users with outstanding gift credits in the block 414, then even if rights to rejected gifts have been transferred to the gift exchange 200, a notification to each of the users for which potential exchange gifts have been found would occur at the block 416. Notifications may be in the form of an email, IM, SMS, message upon logging into the gift exchange 200, or other forms of communication.

Next at the block 418, each user who received notification of a proposed gift exchange is provided the opportunity to accept or reject the proposed gift exchange. If the user (e.g., the gift recipient that rejected the gift giver's selected gift at the block 406) agrees to an exchange (branch 422), then the user is further asked to select between the proposed exchange gift or a gift credit (block 428). In certain embodiments, the value of the gift credit may also be provided to the user in order to decide between a gift or gift credit. If the user selects the gift option (branch 430), then purchase and delivery of the selected gift may take place using the purchase process manager 204 (block 432). Otherwise, if the user does not like the proposed exchange gift, he can select the gift credit option for a future gift exchange (branch 434). The gift credit matching engine 220 returns to the block 412 to update the gift credit (for example, to adjust the gift value associated with that gift credit) and adjust the offered index 214 as needed.

On the other hand, if the user rejects the proposed gift exchange (branch 420) or if at any other time the user desires to exchange the gift, then the transaction manager module 208 provides to the user identifiers, indices, or other information about the user's gift offered for exchange (and any associated requested gift(s) in the requested index 216, if they exist) along with search links, sponsor links, or other aids for the user to self-direct looking for gift exchange possibilities at the block 424. In some embodiments, the transaction manager module 208 may provide a search interface sufficient for the user to query the offered index 214 of unwanted gifts currently registered for possible exchange. The gifts in the requested index 216 may be associated with either a gift credit value or a specific unwanted gift in the offered index 214 that the requesting user is willing to exchange for the exact or similar requested gift item (depending on the matching model being used). Likewise, aggregation of pairs of offered unwanted gifts and requested exchange gifts provides another source for determining valuation or equivalency recommendations. Then at the block 426, the gift credit manager module 210 periodically re-indexes all pending gift credits, for example, to calculate updated values relative to each other. After gift credits are brought up-to-date, matching gift credits to potential exchange gifts can again take place at the block 414.

In alternate embodiments, the gift selected by the gift giver may be actually purchased by the gift giver through vendor sites, but the vendor holds the delivery of the gift until the gift exchange 200 authorizes delivery of the gift and also specifies to whom the gift should be delivered to. In other alternate embodiments, gifts selected by gift givers may be actually purchased and delivered to gift recipients. Hence, gift recipients have possession of gifts until an exchange has been successfully completed using the gift credit matching engine 220, at which time the gift recipients is responsible for shipping the surrendered gift to the new gift recipient. In still other alternate embodiments, the system operator or a third party may have possession of actual gifts until all parties involved in a gift exchange have come to an agreement.

In other embodiments, gifts posted in the offered index 214 may be accessible by everyone, rather than just those users with gift credits. If the gift exchange is made available to the general population, then there may be mechanisms in place, for example included in the gift credit manager module 210, to shield specific users from other users in order to prevent gift givers from knowing that their selected/purchased gifts are being exchanged by their gift recipients.

Accordingly, the gift credit matching engine 220 is operable to provide a distributed web application for managing posting, valuation, matching, re-distribution/exchange, and redemption of unwanted new or used gifts. A barter exchange marketplace is provided that does not evoke tax incurring economic activity. Real-time matching of available gifts to new gift recipients occurs using user profiling and interest-based marketing, facilitating better social utilization of gifts without the negative connotations associated with re-gifting. Unwanted gifts may be dynamically valued relative to each other, current market conditions, and/or relative to relevant users, all of which facilitates successful downstream consumption of unwanted gifts.

In this manner, an intermediary facilitates all stages of the gift giving process to the benefit of gift givers, gift recipients, merchants, and the system operator/owner. Input from interested parties insure that their wishes and likes/dislikes are taken into account, knowledge held by one party that would be beneficial to another party is obtained in an anonymous manner (anonymous from the point of view of the non-input providing parties) to advance the gift giving process while preserving social norms and privacy, and utility of unwanted gifts is addressed. The system operator/owner may also expect higher revenue from sponsors since there is greater probability of click-through, purchase from a sponsoring merchant, or relevancy.

It will be appreciated that the above description for clarity has described embodiments of the invention with reference to different functional units. However, it will be apparent that any suitable distribution of functionality between different functional units may be used without detracting from the invention. Hence, references to specific functional units are only to be seen as references to suitable means for providing the described functionality rather than indicative of a strict logical or physical structure or organization.

The invention can be implemented in any suitable form including hardware, software, firmware or any combination thereof. Different aspects of the invention may be implemented at least partly as computer software or firmware running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

The terms “computer program product,” “computer-readable medium,” and the like may be used generally to refer to media such as, for example, database 111, server 110, or memory 126. These and other forms of computer-readable media may be involved in storing one or more sequences of one or more instructions for use by the client 102, 114, and/or 120 to perform specified operations. Such instructions, generally referred to as “computer program code” (which may be grouped into the form of computer programs or other groupings), when executed, enable the system 100 to perform features or functions of embodiments of the present invention. Note that the code may directly cause the processor to perform specified operations, be compiled to do so, and/or be combined with other software, hardware, and/or firmware elements to do so.

Moreover, although individually listed, a plurality of means, elements, or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method performed using a processor for exchanging unwanted gifts, comprising:
creating a gift credit in response to submission of an unwanted gift, wherein the unwanted gift is submitted by a gift recipient;
identifying at least one exchange gift for the gift credit;
requesting from the gift recipient, exchange of the gift credit for the exchange gift; and
initiating distribution of the exchange gift to the gift recipient if the exchange request is accepted or otherwise providing the gift credit to the gift recipient's account.

2. The method of claim 1, comprising dynamically determining relative values of all gift credits in an unwanted gift registry.

3. The method of claim 2, wherein the exchange gift and the unwanted gift are included in the unwanted gift registry.

4. The method of claim 1, wherein identifying the exchange gift includes identifying matches based on relative comparable value and gift recipient data.

5. The method of claim 4, wherein the gift recipient data includes spatial, temporal, social, or topical data related to the gift recipient, a gift giver, a gift event, or a requested exchange gift or associated user.

6. The method of claim 1, wherein the exchange request is accepted if the exchange gift is responsive to a particular exchange gift proposed by the gift recipient.

7. The method of claim 6, wherein the exchange gift matches the particular exchange gift, a category of the particular exchange gift, a manufacturer of the particular exchange gift, a use or purpose of the particular exchange gift, or a relative resale value of the particular exchange gift.

8. The method of claim 1, comprising identifying at least one advertisement or incentive relating to the exchange gift.

9. An apparatus for redistribution of unwanted gifts, comprising:
a server operable to value unwanted gifts relative to each other and to match a first unwanted gift offered by a first user to a second unwanted gift associated with a second user using a dynamic matching model.

10. The apparatus of claim 9, wherein the dynamic matching model includes matching based on specific user-designated valuations.

11. The apparatus of claim 9, wherein the dynamic matching model includes matching based on specific user requested exchange gifts.

12. The apparatus of claim 9, wherein the dynamic matching model includes matching based on relative value of gifts.

13. The apparatus of claim 9, wherein the dynamic matching model includes matching based on relative relatedness between gifts.

14. The apparatus of claim 9, wherein the dynamic matching model includes matching based on relative relatedness between the first and second users.

15. The apparatus of claim 9, wherein the server is further operable to receive a request for a particular exchange gift from the first user.

16. The apparatus of claim 15, wherein the first user offers the first unwanted gift as a condition of the second unwanted gift at least partially matching the particular exchange gift.

17. The apparatus of claim 16, wherein the second unwanted gift matches the particular exchange gift, a category of the particular exchange gift, a manufacturer of the particular exchange gift, a use or purpose of the particular exchange gift, or a relative resale value of the particular exchange gift.

18. The apparatus of claim 9, wherein the server is further operable to receive a rejection of the first unwanted gift selected by the second user from the first user.

19. The apparatus of claim 18, wherein the server is further operable to create a first gift credit and post the gift credit to a registry, wherein the first gift credit is representative of the first unwanted gift.

20. The apparatus of claim 9, wherein the server is further operable to receive an acceptance of the second unwanted gift offered by the second user from the first user.

21. The apparatus of claim 20, wherein the server is further operable to initiate exchange and delivery of the first and second unwanted gifts in response to the acceptance.

22. The apparatus of claim 9, wherein the server is further operable to prevent matching the first user to the second unwanted gift if the second user is a gift giver of the first unwanted gift to the first user.

23. The apparatus of claim 9, wherein the server is further operable to receive acceptance of the first unwanted gift by the first user.

24. The apparatus of claim 9, wherein the server is further operable to receive acceptance of a gift credit in exchange for the first unwanted gift, the gift credit representative of a gift value of the first unwanted gift and redeemable for a future exchange gift.

25. The apparatus of claim 9, wherein the server is further operable to match at least one advertisement or incentive related to the second unwanted gift for presentation to the first user.

26. A computer-readable medium including computer-readable instructions for exchanging unwanted gifts, the computer-readable instructions for causing performance of a method comprising:
populating an offered index with a plurality of gift credits, each of the gift credits associated with at least an unwanted gift and an intended gift recipient;
determining a match between at least a first gift credit to a second gift credit, wherein the first and second gift credits are included in the offered index; and
requesting a first intended gift recipient associated with the first gift credit to exchange a first unwanted gift associated with the first gift credit for a second unwanted gift associated with the second gift credit.

27. The computer-readable medium of claim 26, wherein determining at least one match includes determining based on specific user-designated valuations.

28. The computer-readable medium of claim 26, wherein determining at least one match includes determining based on specific user requested exchange gifts.

29. The computer-readable medium of claim 26, wherein determining at least one match includes determining based on relative value of gifts.

30. The computer-readable medium of claim 26, wherein determining at least one match includes determining based on relative relatedness between gifts.

31. The computer-readable medium of claim 26, wherein determining at least one match includes determining based on relative relatedness between the first and second users.

32. The computer-readable medium of claim 26, the computer-readable instructions further for redistributing the second unwanted gift to the first intended gift recipient.

33. The computer-readable medium of claim 26, the computer-readable instructions further for issuing the first intended gift recipient the first gift credit in response to refusal of the requested exchange.

34. The computer-readable medium of claim 26, the computer-readable instructions further for periodically calculating relative values of the gift credits to each other.

35. The computer-readable medium of claim 26, the computer-readable instructions further for preventing matching of the first intended gift recipient to the second unwanted gift if the second intended gift recipient is a gift giver of the first unwanted gift to the first intended gift recipient.

36. The computer-readable medium of claim 26, the computer-readable instructions further for determining a match between at least one advertisement or incentive to the second unwanted gift.
